(19) United States
(12) Patent Application Publication
(10) Pub. No.: US 2011/0166786 A1
(43) Pub. Date: Jul. 7, 2011

(54) SYSTEM FOR CORRECTION OF INACCURACIES OF INERTIAL NAVIGATION SYSTEMS

(75) Inventor: Pavel Ing PACES, Svetice (CZ)

(73) Assignee: Ceske vysoke uceni technicke v Praze, Praha 6 (CZ)

(21) Appl. No.: 12/982,127

(22) Filed: Dec. 30, 2010

(30) Foreign Application Priority Data
Jan. 7, 2010 (CZ) PV 2010-11

(51) Int. Cl. G01C 21/16

(52) U.S. Cl. 701/221

(57) ABSTRACT

The system is formed by the first differential pressure sensor where its one input is connected by means of the first pressure feed to the first monitoring point of the body and where its second input is connected by means of the second pressure feed to the second monitoring point. Output of the first differential pressure sensor is connected via amplifying element to the input of analogue-digital converter and its output is connected to the microprocessor system. This is formed by mutually interconnected blocks, specifically the block with inputs, processing unit, memory and the block with output circuits, and together with the whole measuring system it is connected to the block of power supply distribution, which is interconnected with external power supply source. The first output of the microprocessor system is connected to display device. The first monitoring point and the second monitoring point are located symmetrically in relation to the centre of gravity of the body. Microprocessor system is equipped with the second output used to control external devices.

### BACKGROUND OF THE INVENTION

The invention deals with a system for measuring inclinations of a body in space for orientation and navigation purposes, which corrects inaccuracies of inertial navigation systems. The solution takes the advantage of known placement of sensors and measured differences of pressures given by the Earth's atmosphere characteristics. Method used by the system is in particular suitable for improving the precision of data produced by inertial sensors in small airplanes.

### DESCRIPTION OF PRIOR ART

Airplanes travelling in the Earth's aerosphere define their orientation in space, so called position angles, i.e. pitch angle, see FIG. 1A, and roll angle, see FIG. 1B, based on visual perceptions during so-called visual meteorological conditions or based on signals from instruments during so-called instrument meteorological conditions. During visual meteorological conditions, the pilot determines orientation using the horizon line, which serves him/her to maintain the airplane in desired orientation. During instrument meteorological conditions, the horizon line is displayed by one of the instruments on the dashboard. Information about the airplane's inclinations is measured by means of sensors, which continuously monitor acceleration, so-called accelerometers, and angular velocity in all three axes of the airplane. The unit measuring the orientation in space is called a gyroscope or an inertial navigation unit. In practice, the systems used are based on optical principle, on principle of rotating mass inertia and on movement of mass element on a trajectory. Systems based on rotating mass inertia principle, i.e. mechanical gyroscopes, suffer with issues relating to rotating mechanical part of the measuring system. These instruments are mechanically challenging for production and maintenance, and therefore expensive. Systems based on optical principle determine the angular velocity by interference of lights generated by the light source when passing the optical paths of various lengths. In practice, they are referred to as laser gyroscopes, which are very precise and very expensive.

Micro-mechanical systems called MEMS, widely developed in recent time and inexpensive, work on a principle using the movement of mass element on a flexible arm, which is formed within a silicon structure. Movement of mass element is detected by various principles, for instance change of capacity between electrodes. Unfortunately, precision of this system is not sufficient for navigation applications and is rather dependent on ambient environment aspects, such as temperature. When these sensors are used in inertial navigation unit, the output value drifts over time above negligible levels, when the measured parameter slowly passes to an inaccurate value as a result of imprecisions during the sensors production, imprecisions of measuring chain and the processing system, such as numerical integration of data. Such inaccuracy becomes evident during tens of minutes.

### SUMMARY OF THE INVENTION

The above mentioned setbacks of inertial systems are removed by the system for correction of inaccuracies of inertial navigation systems based on measuring the body inclinations in atmosphere, which is subject to constantly identical error of measurement.

Principle of the new system is that it is formed by the first differential pressure sensor where its one input is connected by means of the first pressure feed to the first monitoring point of the body and where its second input is connected by means of the second pressure feed to the second monitoring point. Output of the first differential pressure sensor is connected via amplifying element to the input of analogue-to-digital converter and its output is connected to the microprocessor system. This microprocessor system is formed by mutually interconnected blocks, specifically the block with inputs, processing unit, memory and the block with output circuits, and together with the whole measuring system it is connected to the block of power supply distribution, which is interconnected with external power supply source by means of power supply input. The first output of the microprocessor system is connected to a display device. The first and the second monitoring points are located symmetrically in relation to the centre of gravity of the body. Microprocessor system is further equipped with the second output used to control external devices.

In one advantageous embodiment the first output of the microprocessor system is at the same time connected to the correction block, to which is also connected the output of the inertial navigation system. This correction block is equipped with an interface with the inertial navigation system data with improved precision.

In another advantageous embodiment the system includes second differential pressure sensor with inputs connected to the opposite ends of the first and second pressure feeds than the inputs of the first differential pressure sensor. The amplifying element in this case is designed as a differential amplifier where the output of the first differential pressure sensor is connected to the amplifier's inverting input and the output of the second differential pressure sensor is connected to the amplifier's non-inverting input.

Yet another advantageous embodiment is such when the inputs of the first and second differential pressure sensors are connected to the first and second pressure feeds via pressure switch, which is connected to the second output of the microprocessor system.

The advantage of the proposed system is that the airplane inclinations are measured by completely different method from those commonly used at present. The system allows to measure inclination of a body in atmosphere subject to a constant and over time non-increasing error, which is not further augmented by integration in processing system. Based on described reasons the proposed system may be used as a correction element for outputs of inexpensive inertial navigation sensors.

### OVERVIEW OF FIGURES IN DRAWINGS

System for correction of inaccuracies of inertial navigation systems and its functions are further described by means of attached drawings.

FIGS. 1A and 1B show examples of location of measuring points and other data for implementation of the measurement on airplane, while FIG. 1A shows pitch angle of the airplane and FIG. 1B shows airplane's roll angle.

FIG. 2 shows a block diagram of the measuring system connection.

FIG. 3 shows dependence of pressure difference relating to one meter and height above the land surface.

### DETAILED DESCRIPTION OF THE PREFERRED EMBODIMENTS

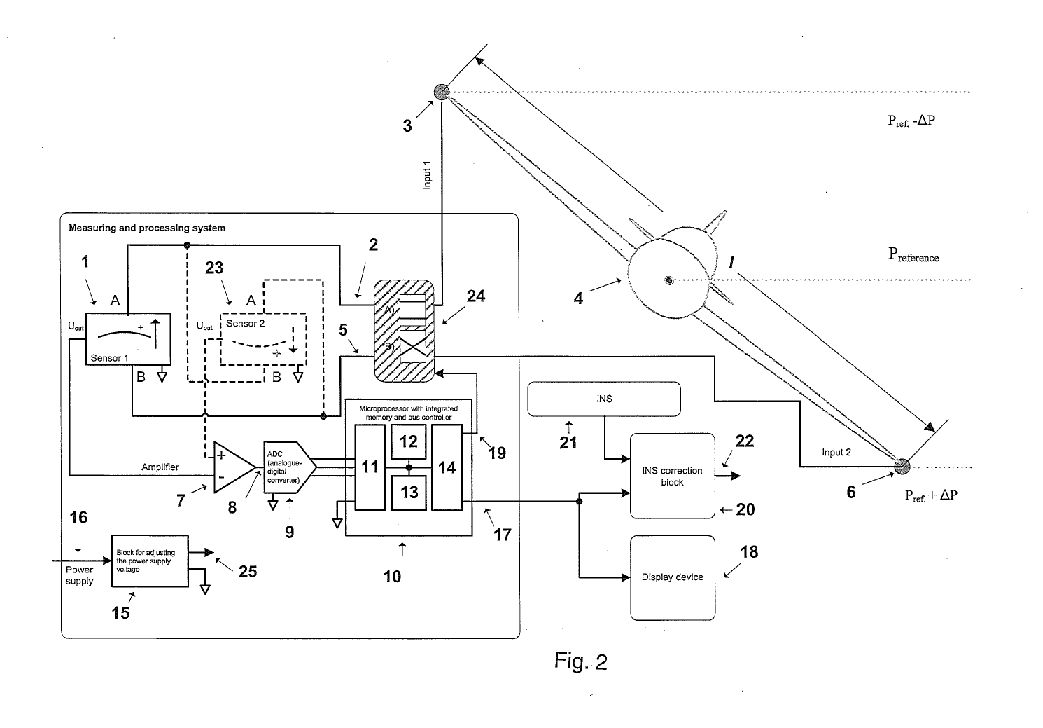

System for correction of inaccuracies of inertial navigation systems according to the example shown in FIG. 2 is formed by the first differential pressure sensor 1 where its one input is connected by means of the first pressure feed 2 to the first monitoring point 3 of the body 4, which in this case is an airplane. The second input of the first differential pressure sensor 1 is connected by means of the second pressure feed 5 to the second monitoring point 6 and its output is connected via the amplifying element 7 by means of a conductor 8 to the input of the analogue-to-digital converter 9. Output of the analogue-to-digital converter 9 is connected to the microprocessor system 10. Microprocessor system 10 is formed by mutually interconnected blocks, specifically the block 11 with inputs, processing unit 12, memory 13 and the block 14 with output circuits, and together with the whole measuring system it is connected to the block 15 of power supply distribution by means of output 25, which is interconnected with external power supply source by means of power supply input 16. Detailed interconnection is not shown in the drawing to maintain better understanding. The first output 17 of the microprocessor system 10 is connected to a display device 18. The first monitoring point 3 and the second monitoring point 6 are located symmetrically in relation to the centre of gravity of the body 4 and the microprocessor system 10 is equipped with the second output 19 used to control external devices. This describes the basic embodiment of the system. FIG. 2 indicates however also its possible modifications. One of such modifications is that the first output 17 of the microprocessor system 10 is at the same time connected to the correction block 20, to which is also connected the output 21 of the inertial navigation system. Correction block 20 is equipped with an interface 22 with the inertial navigation system data with improved precision.

Another modification of the system is that it includes second differential pressure sensor 23 with inputs connected to the opposite ends of the first pressure feed 2 and the second pressure feed 5 than the inputs of the first differential pressure sensor 1. The amplifying element 7 in this case is designed as a differential amplifier where the output of the first differential pressure sensor 1 is connected to the amplifier's inverting input and the output of the second differential pressure sensor 23 is connected to the amplifier's non-inverting input.

Yet another modification option is that the inputs of the first differential pressure sensor 1 and the second differential pressure sensor 23 are connected to the first pressure supply 2 and the second pressure supply 5 via pressure switch 24, which is connected to the second output 19 of the microprocessor system 10.

Principle of the measurement is the loss of atmospheric air pressure in dependence on height and the fact that the body 4, an airplane in given example, consists of symmetrically placed elements, which during flight change their positions in relation to the airplane's center of gravity mirror-wise. For example, if the airplane turns, the end of wing on the inner side of turn is located below the center of gravity, while the wing on the opposite side is elevated above the center of gravity. This inclination creates differences both in distance and pressure between the points at the ends of the right and left wings in vertical plane. In this case applies that vertical distance is the longer, the longer is the length of a wing and the steeper the airplane's inclination. The method of measuring the inclination using the principle of measuring the pressure difference in different places of the airplane structure by differential pressure sensor is based on physical properties of atmosphere, which are described by equation:

$$H = \frac{{T}_{0}}{τ} \cdot [ {( \frac{p ( 0 )}{p ( H )} )}^{R \cdot τ} - 1 ] . \qquad ( 1 )$$

### Where

H is height measured from reference level p(0)[m],
p(0) is atmospheric pressure corresponding to the reference level [kPa],
p(H) is atmospheric pressure corresponding to the height H [kPa],
T₀ is absolute temperature in zero height ISA [K],
T is factor of temperature dependence for heights from 0 to 11 km according to ISA [K m⁻¹] and
R is corrected gas constant for air according to ISA [m K⁻¹].

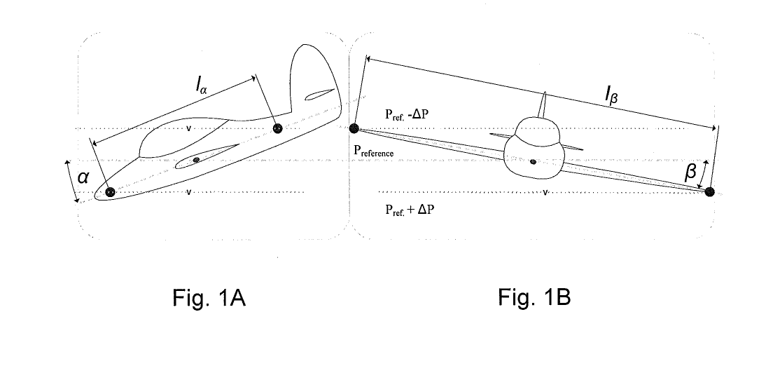

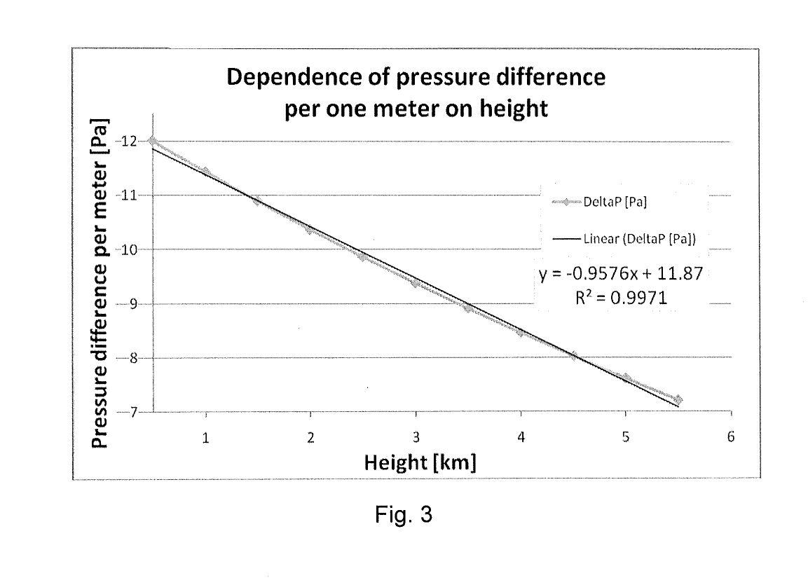

The method of measuring the inclination using the principle of measuring the pressure difference in different places of the airplane structure is based on a presumption that the air pressure profile in the area determined by the mutually most distant points of the airplane structure in individual heights is constant, see equation (1) and FIG. 1A, 1B. Equation (1) was used to determine the dependence of pressure difference related to one meter and height above the land surface, which is shown in FIG. 3. FIG. 3 indicates that pressure difference at the sea level is approximately 12 Pa/1 m and 7 Pa/1 m in the height of 5 km. Such values can be measured by sensors with small range.

During a flight, the airplane changes its position in space and different points of its structure get into places located symmetrically in relation to the center of gravity. These points serve as inputs for the measuring system, which measures instantaneous pressure difference at the inputs, which allows to distinguish inclinations of the airplane, see FIGS. 1A and 1B. Value of output voltage dependence on the angle of the airplane inclination can be, referring to FIG. 1A, described by equation (2), which depends on angle α and on distance of points l_{α}. Situation in FIG. 1B can be described by analogical equation for angle β and distance l_{β}.

$${U}_{out} = \frac{Δ {P}_{1 m}}{1} \cdot {l}_{a} \cdot sin ( α ) \cdot \frac{Δ {U}_{sens .}}{Δ {P}_{range}} . \qquad ( 2 )$$

### Where

Uₒᵤₜ is output voltage measured at the detecting element of a pressure sensor [V],
ΔP₁ₘ is pressure difference corresponding to the height of 1 m [Pa],
l_{α} is distance of symmetrically located measuring inputs [m],
α is angle of the airplane inclination from the plane passing through the airplane's center of gravity that is parallel in relation to land surface [°],
ΔU_{sens.} is output range of voltage of differential pressure sensor [V] and
ΔP_{range} is range of pressures measured by differential pressure sensor [Pa].

Measuring system is based on principle of pressure difference detection as shown in FIG. 1. The system uses the first differential pressure sensor 1, which is connected in the airplane in the example of connection as show in FIG. 2. FIG. 2 defines detection system, which is equipped with two inputs measuring the pressure difference and at its output it provides a voltage signal proportional to the airplane inclination.

Detection system precision can be enhanced by using two sensors, the first differential pressure sensor 1 and the second differential pressure sensor 23, with their inputs connected to the opposite ends of the first pressure feed 2 and the second pressure feed 5. In case the differential voltage between the outputs of the differential first differential pressure sensor 1 and the second differential pressure sensor 23 is measured, the result is double the amplitude of the output signal. Mathematically, the change of the output voltage against reference pressure can be described by equation (3) and, analogically, for the second sensor by equation (4). Subtraction of equations (3) and (4) gives resulting change of output voltage of sensor, which is proportional to fourfold of pressure difference between the reference level and measuring input.

ΔU₁=f(P_{REF}+ΔP)−f(P_{REF}−ΔP)=2·f(ΔP). (3)

ΔU₂=−(f(P_{REF}+ΔP)−f(P_{REF}−ΔP))=−2·f(ΔP) (4)

ΔUₒᵤₜ=ΔU₁−ΔU₂=2·f(ΔP)+2·f(ΔP)=4·f(ΔP) (5)

Precision of the measuring system can be even more enhanced by switching the connection of the first pressure feed 2 and the second pressure feed 5 to the first monitoring point 3 and the second monitoring point 6 in the former case, and to the second monitoring point 6 and the first monitoring point 3 in the latter case. The switching causes mutual swapping of the first monitoring point 3 and the second monitoring point 6 by means of pressure switch 24. Using the pressure switch 24, which is controlled by the output 19 of the microprocessor system 10, the value of signal for two mutually opposite positions of the airplane, inclination can be measured. Average from thus measured values gives instantaneous value of inclination angle where no other impacts apply, such as the output signal drift affecting the detecting element of the sensor.

The output signal of the first differential pressure sensor 1 can be described by equation (6) and, analogically, the output signal of the second differential pressure sensor 23 can be described by equation (7). Average of both values, see equation (8), after substitution, is detailed in equation (9). Result value described by equation (10) is independent on offsets of individual sensors and provides the output value of voltage, which is in proportion to the body inclination.

$$\begin{matrix}{U}_{out 1} = f ( 4 \cdot f ( Δ P ) ) + {U}_{offset 1} + {U}_{offset 2} & ( 6 ) \\ {U}_{out 2} = f ( - 4 \cdot f ( Δ P ) ) + {U}_{offset 1} + {U}_{offset 2} & ( 7 ) \\ {U}_{out \_ corrected} = \frac{{U}_{out 1} - {U}_{out 2}}{2} & ( 8 ) \\ {U}_{out \_ corrected} = \frac{\begin{matrix}f ( 4 \cdot f ( Δ P ) ) + {U}_{offset 1} + {U}_{offset 2} - \\ ( f ( - 4 \cdot f ( Δ P ) ) + {U}_{offset 1} + {U}_{offset 2} )\end{matrix}}{2} & ( 9 ) \\ {U}_{out \_ corrected} = \frac{f ( 8 \cdot f ( Δ P ) )}{2} = f ( 4 \cdot f ( Δ P ) ) & ( 10 )\end{matrix}$$

For measuring the output signal from the first differential pressure sensor 1 and from the second differential pressure sensor 23 is used a differential amplifier 7 and its analogue output is connected by conductor 8 to analogue-to-digital converter 9, which converts the signal to its digital representation, which is led to the block 11 with inputs of the microprocessor system 10 and subsequently processed by the processing unit 12 and memory 13. Block 14 with output circuits serves to adjust the signal for controlling the pressure switch 24 and to adjust the signal on physical layer of the first output 17 of the microprocessor system 10, which transfers the processed value of the body 4 inclination to a display device 18 placed in the body 4 dashboard and to the correction block 20, which at the same time receives signal from the inertial navigation system 21 and on the output formed by the interface 22 it provides signal corrected by errors caused by time instability of sensors used in the inertial navigation system 21. Microprocessor system 10, based on known position of the pressure switch 24 and measured value of the output signal of the analogue-to-digital converter 9, calculates instantaneous value of inclination, which is further transferred by the first output 17 of the microprocessor system 10.

### INDUSTRIAL APPLICABILITY

System for correction of inaccuracies of inertial navigation systems according to the submitted solution will find use in particular in the area of small airplanes, where the Czech Republic belongs among the greatest manufacturers and exporters of small airplanes in the world. The system will allow to correct drift of inexpensive inertial navigation systems. Such corrected inertial navigation units would subsequently increase safety of the airplane flights, safety of pilots and safety of people and property on the ground. This method may be implemented to improve precision of inertial systems travelling in atmosphere within heights ranging from 0 to approximately 5 km.

1. System for correction of inaccuracies of inertial navigation systems containing an amplifying element connected via an analogue-digital converter to microprocessor system, which is formed by mutually interconnected blocks, specifically the block with inputs, processing unit, memory and the block with output circuits, and which, together with the whole measuring system, is connected to the block of power supply distribution by means of output, interconnected with external power supply source, wherein it is formed by the first differential pressure sensor where its one input is connected by means of the first pressure feeds to the first monitoring point of the body and where its second input is connected by means of the second pressure supply to the second monitoring point, and its output is connected via the amplifying element and analogue-digital converter to the microprocessor system, and the first output of the microprocessor system is connected to a display device, while the first monitoring point and the second monitoring point are located symmetrically in relation to the centre of gravity of the body and the microprocessor system is equipped with the second output used to control external devices.

2. System according to claim 1 wherein the first output of the microprocessor system is at the same time interconnected with correction block, to which the output of the inertial navigation system is also connected where this correction block is equipped with an interface with the inertial navigation system data with improved precision.

3. System according to claim 1 wherein it includes second differential pressure sensor with inputs connected to the opposite ends of the first pressure feed and the second pressure feed than the inputs of the first differential pressure sensor, and the amplifying element is designed as a differential amplifier where the output of the first differential pressure sensor is connected to the amplifier's inverting input and the output of the second differential pressure sensor is connected to the amplifier's non-inverting input.

4. System according to claim 3 wherein the inputs of the first differential pressure sensor and the second differential pressure sensor are connected to the first pressure feed and the second pressure feed via pressure switch, which is connected to the second output of the microprocessor system.

5. System according to claim 2 wherein it includes second differential pressure sensor with inputs connected to the opposite ends of the first pressure feed and the second pressure feed than the inputs of the first differential pressure sensor, and the amplifying element is designed as a differential amplifier where the output of the first differential pressure sensor is connected to the amplifier's inverting input and the output of the second differential pressure sensor is connected to the amplifier's non-inverting input.
